(19) United States
(12) Patent Application Publication
(10) Pub. No.: US 2020/0050183 A1
(43) Pub. Date: Feb. 13, 2020

(54) STATUS COLLECTING SYSTEM

(71) Applicant: NIPPON SEIKI CO., LTD., Niigata (JP)

(72) Inventors: Satoshi OTA, Niigata (JP); Yasuo SORIMACHI, Niigata (JP)

(21) Appl. No.: 16/340,643

(22) PCT Filed: Oct. 13, 2017
(86) PCT No.: PCT/JP2017/037150

§ 371 Date: Apr. 9, 2019

(30) Foreign Application Priority Data
Oct. 25, 2016 (JP) 2016-208806

(51) Int. Cl. G05B 23/02; G05B 15/02

(52) U.S. Cl. CPC G05B 23/0272; G05B 23/0283; G05B 23/0216; G05B 23/0213; G05B 15/02

(57) ABSTRACT

The present invention provides a status collecting system that simplifies the work associated with installation of detection devices for detecting the status of objects to be measured and/or the work associated with reporting the contents of work performed by a worker. A plant-equipment status collecting system includes: detection devices; a network construction device; a data storage device; data storage cards; and a mobile terminal. The data storage cards store information and can contactlessly communicate with the mobile terminal. The mobile terminal has a tag controller that can contactlessly and automatically read the information from the data storage cards and can contactlessly and automatically cause tag parts of the detection devices to store the read information. The detection devices perform predetermined operations when the information is stored in the tag parts.

### TECHNICAL FIELD

The present invention relates to a status collecting system. The present invention particularly relates to a status collecting system that simplifies work related to installation of a detection device for detecting a status of a predetermined measured object and/or work related to reporting work contents of an operator.

### BACKGROUND ART

For example, Patent Document 1 discloses a plant-equipment status collecting system including a detection device, a mobile terminal, a network construction device, and a data storage device. In the plant-equipment status collecting system disclosed in Patent Document 1, the detection device includes a detection unit configured to detect a status of a plant equipment disposed in a plant, a network connection unit connectable to a network constructed by the network construction device, and a tag part capable of storing at least a part of setting information including network information for connecting to at least the network from the mobile terminal, wherein the detection device transmits at least a status of the plant equipment detected by the detection unit and identification information for identifying the detection device to the network construction device via the network, the mobile terminal includes a tag controller capable of automatically storing at least a part of the setting information in the tag part of the detection device in a non-contact manner, and is configured to communicate with the data storage device, the data storage device includes a storage unit configured to store at least the status of the plant equipment and the identification information of the detection device received from the network construction device, and the network construction device determines, when the network information is stored in the tag part of the detection device by the mobile terminal, whether or not to permit the detection device to connect the network by using the network information.

In the plant-equipment status collecting system disclosed in Patent Document 1, an operator can automatically store the network information input to the mobile terminal in the detection device in a non-contact manner. That is, for example, the operator does not need to perform an operation for storing the network information in the detection device for the mobile terminal wired to the detection device. Therefore, since the operator is free from work for connecting and disconnecting a cable connecting the mobile terminal and the detection device or the like, it is possible to simplify the work of attaching the detection device to the plant equipment.

### PRIOR ART DOCUMENT

### Patent Document

Patent Document 1: Japanese Unexamined Patent Application Publication No. 2016-139227

### SUMMARY OF THE INVENTION

### Problems to be Solved by the Invention

Incidentally, in the plant-equipment status collecting system disclosed in Patent Document 1, a tablet terminal including an input unit and a display unit, such as a touch panel type display module, in order to allow the operator to manually input information to be stored in a non-contact manner in the tag part of the detection device, is used as the mobile terminal. Further, the operator inputs work contents, such as checking and repairing the plant equipment, to the tablet terminal through a touch operation or the like with a touch panel type display module, and it is possible to transmit them to the data storage device (cloud server) through wireless communication.

However, if the operator manually inputs setting information with the touch panel type display module of the tablet terminal in the case where the detection device is installed in the plant (when newly installed or replaced), it makes the installation work complicated such as causing input errors or taking an input confirmation time, and results in complicated work of attaching the detection device to the plant equipment as a whole. Likewise, when the work contents are also reported, reporting work becomes complicated, such as causing input errors and taking an input confirmation time, and accordingly, work of running the plant-equipment status collecting system becomes complicated as a whole. In this situation, there is room for improvement in work of installing the detection device in the plant-equipment status collecting system and work of reporting the work contents of the operator.

An object of the present invention is to provide a status collecting system that simplifies work related to installation of a detection device for detecting a status of a predetermined measured object and/or work related to reporting work contents of an operator.

### Solution to Problem

A status collecting system of the present invention includes a detection device, a network construction device, a data storage device, a data storage card, and a mobile terminal, wherein

the detection device includes a detection unit configured to detect a status of a predetermined measured object and a tag part configured to store predetermined information in a non-contact manner, and transmits at least the status detected by the detection unit and detection device identification information for identifying the detection device to the network construction device through a network constructed by the network construction device,

the data storage device includes a storage unit configured to store at least the status and the detection device identification information received from the network construction device,

the data storage card stores the information and is communicatable with the mobile terminal in a non-contact manner,

the mobile terminal includes a tag controller configured to automatically read the information from the data storage card in a non-contact manner and to automatically store the information read in the tag part of the detection device in a non-contact manner, and

the detection device performs a predetermined operation when the information is stored in the tag part.

### Effect of the Invention

According to the present invention, it is possible to simplify work related to installation of the detection device that detects the status of the predetermined measured object and/or work related to reporting work contents of the operator.

### BRIEF DESCRIPTION OF THE DRAWINGS

FIG. 1 is a diagram illustrating an example of the overall configuration of a plant-equipment status collecting system of the present invention.

FIG. 2A is a diagram illustrating an example of internal structures of components of the plant-equipment status collecting system illustrated in FIG. 1.

FIG. 2B is a diagram illustrating an example of a data structure of network construction information stored in a network construction device illustrated in FIG. 1 and plant information stored in a data storage device illustrated in FIG. 1.

FIG. 2C is a diagram illustrating an appearance of a mobile terminal illustrated in FIG. 1.

FIG. 2D is a diagram illustrating an example of a data storage card illustrated in FIG. 1.

FIG. 2E is a diagram illustrating an example of operations of storing information in a tag part of a detection device and acquiring information from the tag part, by a tag controller of the mobile terminal illustrated in FIG. 2A.

FIG. 2F is a diagram illustrating a status transition of the mobile terminal illustrated in FIG. 1.

FIG. 2G is a diagram illustrating a status transition of the tag controller of the mobile terminal illustrated in FIG. 2A.

FIG. 2H is a diagram illustrating an example of an operation of a light emitting unit and a buzzer of the mobile terminal illustrated in FIG. 2A.

FIG. 3A is a flowchart illustrating an example of an operation in which the plant-equipment status collecting system illustrated in FIG. 1 collects a status of a plant equipment.

FIG. 3B is a diagram illustrating an example of a data structure used in the operation illustrated in FIG. 3A.

FIG. 4A is a flowchart illustrating an example of work of attaching the detection device illustrated in FIG. 1.

FIG. 4B is a diagram illustrating an example of a data structure used in the work illustrated in FIG. 4A.

FIG. 4C is a diagram illustrating work using the mobile terminal illustrated in FIG. 1 in the work illustrated in FIG. 4A.

FIG. 5A is a flowchart illustrating an example of work of transmitting work contents by using the mobile terminal illustrated in FIG. 1.

FIG. 5B is a diagram illustrating an example of a data structure used in the work illustrated in FIG. 5A.

FIG. 5C is a diagram illustrating work using the mobile terminal illustrated in FIG. 1 in the work illustrated in FIG. 5A.

### MODE FOR CARRYING OUT THE INVENTION

An embodiment described below is used for easy understanding of the present invention. Accordingly, one skilled in the art should be aware that the present invention is not unduly limited by the embodiment described below.

«1. Overall Configuration»

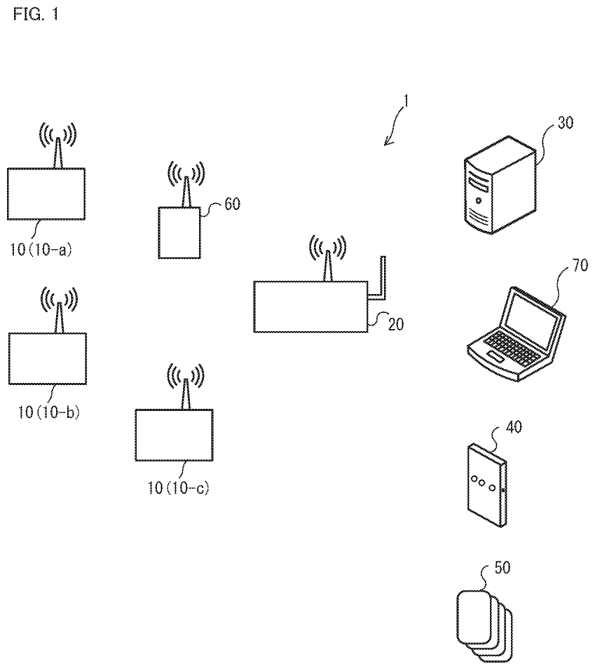

As illustrated in FIG. 1, a status collecting system 1 includes a detection device 10, a network construction device 20, a data storage device 30, a mobile terminal 40, and a data storage card 50. A plurality of the detection devices 10 are provided, and each detection device 10 is attached to a corresponding plant equipment among a plurality of plant equipments arranged in a plant not illustrated. The plurality of detection devices 10 can be connected to a wireless sensor network (WSN) using a standard such as a wireless LAN (Local Area Network) and ZigBee (registered trademark) constructed by the network construction device 20. It is preferable that the WSN is a so-called mesh type network. That is, it is preferable that the plurality of detection devices 10 are connected to the network construction device 20, and each detection device 10 (for example, a detection device 10-b) is connected to one or more of the other detection devices 10 (for example, a detection device 10-a and a detection device 10-c) adjacent to the detection device 10. Further, when there is a detection device 10 (for example, the detection device 10-a) incapable of being directly connected to the WSN due to a distance from the network construction device 20 or the like, the plant-equipment status collecting system 1 may further include a repeater 60 to interpolate the connectable range of the WSN.

The network construction device 20 is configured to use mobile communication such as 3G line or LTE (Long Term Evolution) line. Hereinafter, “mobile communication such as 3G line or LTE line” is also referred to as “3G/LTE”. The network construction device 20 is configured to communicate with the data storage device 30 through 3G/LTE.

In the example illustrated in FIG. 1, the three detection devices 10-a, 10-b, and 10-c are illustrated to be connected to the WSN constructed by the network construction device 20, but four or more detection devices 10 connected to the WSN may be used, or one or two detection devices 10 may be used. Further, the actual plant-equipment status collecting system 1 includes a plurality of network construction devices (the network construction device 20 in FIG. 1 and one or more other network construction devices not illustrated). To the one or more other network construction devices not illustrated, a plurality of detection devices not illustrated are connected as in FIG. 1.

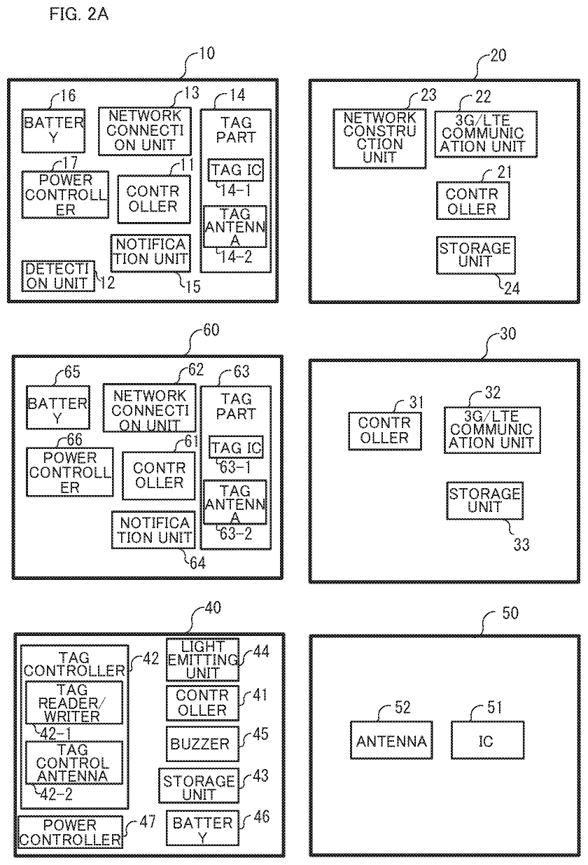

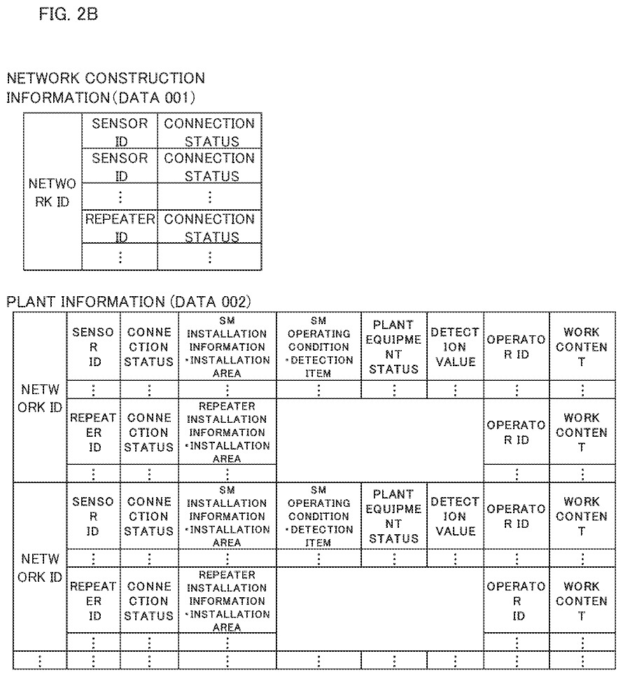

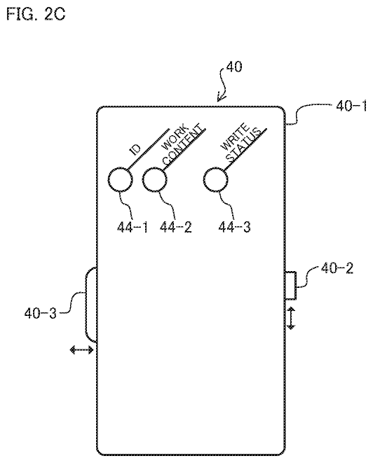

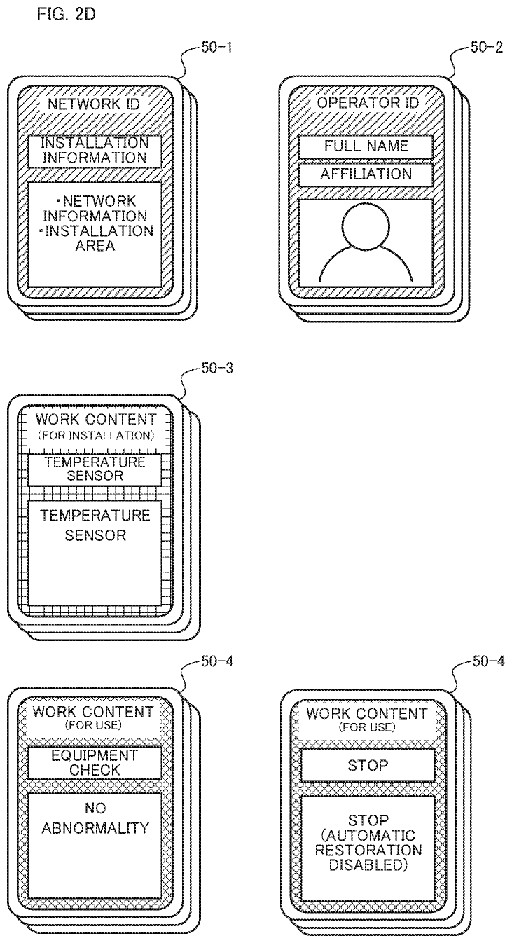

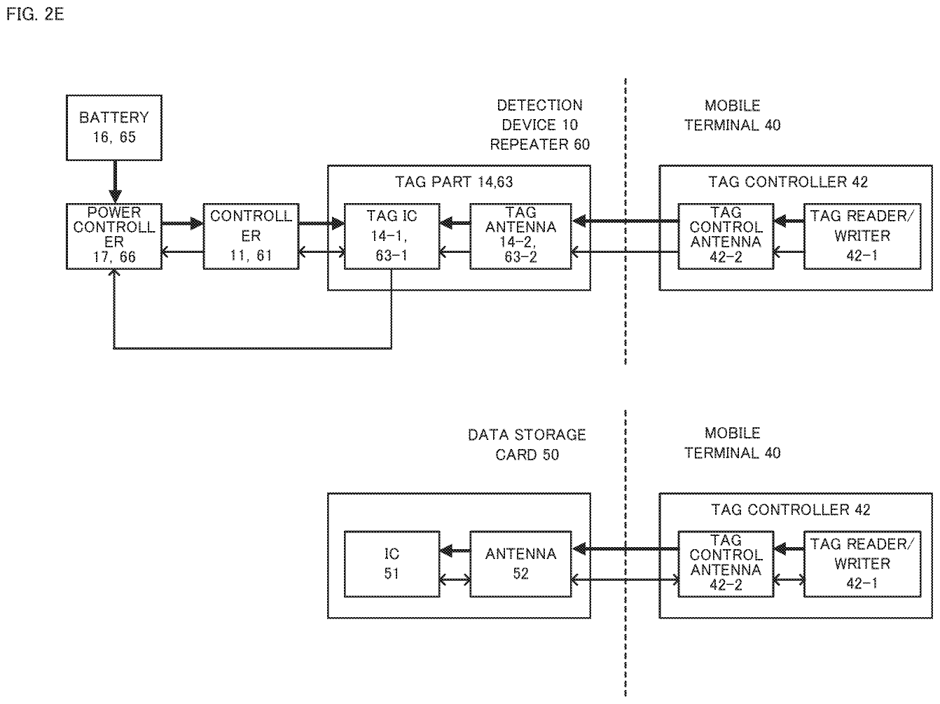

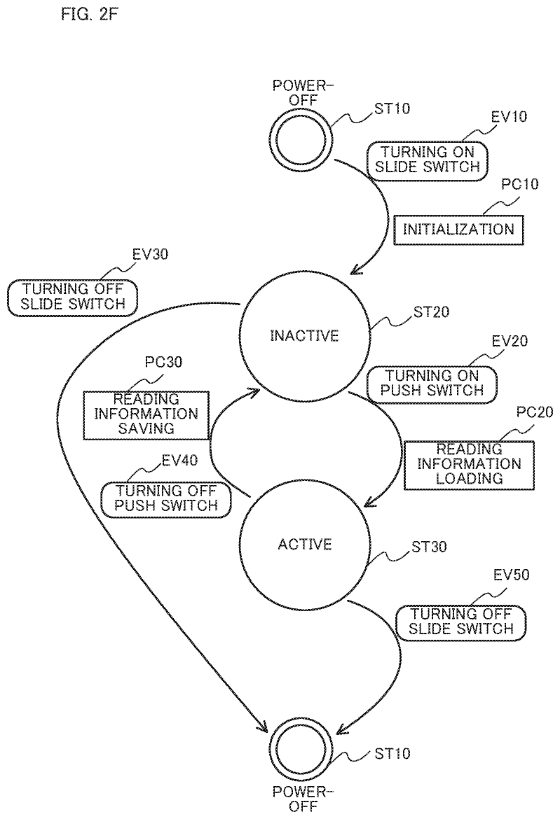

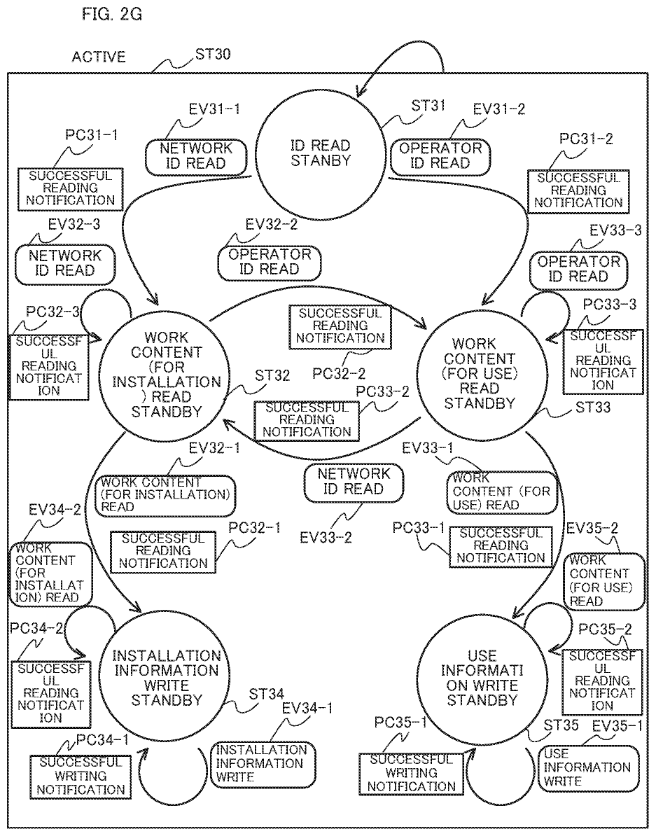

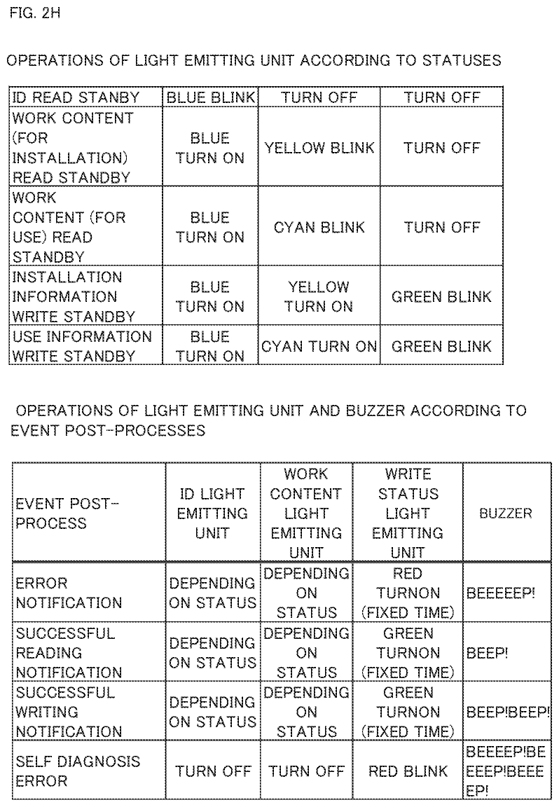

In FIG. 2A, an example of the internal configurations of components of the plant-equipment status collecting system 1 illustrated in FIG. 1 is illustrated. The detection device 10 illustrated in FIG. 2A includes a controller 11, a detection unit 12, a network connection unit 13, a tag part 14, and a notification unit 15. Since it is assumed that the detection device 10 is attached to a place where a power supply cable or the like not illustrated hardly supplies electric power to, it is preferable that the detection device 10 further includes a battery 16. Further, the detection device 10 may further include a power controller 17 that controls power supply from a power cable or the battery 16 to at least one of, for example, the controller 11, the detection unit 12, the network connection unit 13, the tag part 14, and the notification unit 15. The power controller 17 includes a self-holding circuit including, for example, a switching element such as a relay sequence or a transistor. Hereinafter, the “detection device 10” is also referred to as the “sensor module 10”.

The controller 11 of the detection device 10 is composed of, for example, a microcomputer and controls the operations of the detection unit 12, the network connection unit 13, the tag part 14, and the notification unit 15. Further, the controller 11 may be configured to further acquire the remaining amount of the battery 16, for example. The detection unit 12 of the detection device 10 detects the status of a plant equipment to which the detection device 10 is attached. Here, the plant equipment is, for example, a steam trap, a rotating machine or the like, and the status of the plant equipment is, for example, the temperature, vibration, humidity, pressure, ph of the plant equipment.

The network connection unit 13 of the detection device 10 is configured to be connected to the WSN constructed by the network construction device 20. The tag part 14 of the detection device 10 is an RF (Radio Frequency) tag having a tag IC (integrated circuit) 14-1 and a tag antenna 14-2 used for NFC (Near Field Communication), for example. The tag part 14 is configured so that a tag controller 42 of the mobile terminal 40 described later can store information by writing information to the tag IC 14-1 in a non-contact manner, for example. Here, the non-contact means that the tag part 14 of the detection device 10 and the tag controller 42 of the mobile terminal 40 do not contact mechanically with each other in a direct state or an indirect state by wiring the tag part 14 of the detection device 10 and the tag controller 42 of the mobile terminal 40 by, for example, a cable. Further, for example, a sensor ID or detection device identification information for identifying the detection device 10, is stored in advance in the tag part 14, more specifically, the tag IC 14-1.

The notification unit 15 of the detection device 10 is, for example, an LED, a buzzer, or the like, and is activated or stopped under the control of the controller 11. The battery 16 of the detection device 10 supplies electric power to at least the controller 11 when the detection device 10 is in a power-on status. The electric power may be supplied to the detection unit 12, the network connection unit 13, the tag part 14, and the notification unit 15 via, for example, the controller 11, or may be supplied without going through the controller 11.

The network construction device 20 illustrated in FIG. 2A includes a controller 21, a 3G/LTE communication unit 22, a network construction unit 23, and a storage unit 24. Hereinafter, the “network construction device 20” is also referred to as the “sensor gate module 20”.

The controller 21 of the network construction device 20 is composed of, for example, a microcomputer and controls the operations of the 3G/LTE communication unit 22, the network construction unit 23, and the storage unit 24. The network construction device 20 makes it possible to connect to the 3G/LTE by including the 3G/LTE communication unit 22. Further, the network construction device 20 makes it possible to construct a WSN by including the network construction unit 23. The WSN constructed by the network construction device 20 is provided with, for example, a network ID or network identification information for identifying that it is a WSN constructed by the specific network construction device 20.

The storage unit 24 of the network construction device 20 stores, for example, network construction information (data 001) of the WSN constructed by the network construction device 20, illustrated in FIG. 2B. The network construction information (data 001) includes, for example, a network ID, a sensor ID of the detection device 10 connected to the WSN identified by this network ID, and a list of connection statuses of these detection devices 10 to the WSN. If the repeater 60 is connected to the WSN identified by the network ID, the network construction information (data 001) may further include a repeater ID and a connection status of the repeater to the WSN.

The data storage device 30 illustrated in FIG. 2A includes a controller 31, a 3G/LTE communication unit 32, and a storage unit 33. Hereinafter, the “data storage device 30” is also referred to as the “cloud server 30”.

The storage unit 33 of the data storage device 30 stores, for example, plant information (data 002) illustrated in FIG. 2B. The plant information (data 002) includes, for example, a plurality of network IDs, a sensor ID of the detection device 10 connected to the WSN identified by each network ID, a connection status of the detection device 10, installation information (SM (Sensor module) installation information) of the detection device 10, an operating condition (SM operating condition) of the detection device 10, a status of the plant equipment, a detection value detected by the detection device 10, an operator ID, and work contents. The installation information of the detection device 10 includes, for example, an installation area such as an address in the plant. The operating condition of the detection device 10 includes, for example, detection items detected by the detection unit 12 of the detection device 10. When there is a WSN to which the repeater 60 is connected, it may further include a repeater ID, a connection status to the WSN, and installation information of the repeater. The plant information (data 002) includes all items of the network construction information (data 001).

The mobile terminal 40 illustrated in FIG. 2A includes a controller 41, a tag controller 42, a storage unit 43, a light emitting unit 44, and a buzzer 45 (an example of a sound output unit). Since it is assumed that the mobile terminal 40 is carried in the plant by the operator working in the plant, it is preferable that the mobile terminal 40 further includes a battery 46. Further, the mobile terminal 40 includes a power controller 47 that controls power supply from the battery 46 to at least one of, for example, the controller 41, the tag controller 42, the storage unit 43, the light emitting unit 44, and the buzzer 45. The power controller 47 includes a self-holding circuit including, for example, a switching element such as a relay sequence or a transistor. The mobile terminal 40 performs the acquisition of information only by the tag controller 42 and does not include a display unit and an input unit such as a touch panel type display for the operator to perform input operation. Hereinafter, the “mobile terminal 40” is also referred to as the “knocker 40”.

The controller 41 of the mobile terminal 40 is composed of, for example, a microcomputer and controls the operations of the tag controller 42, the storage unit 43, the light emitting unit 44, and the buzzer 45. That is, the controller 41 functions as a light emission controller and a sound controller. Further, the controller 41 may be configured to further acquire the remaining amount of the battery 46, for example. The tag controller 42 of the mobile terminal 40 includes a tag reader/writer 42-1 and a tag control antenna 42-2. The tag controller 42 can store information by writing information to the tag part 14 of the detection device 10 in a non-contact manner. When information is stored in the tag part 14, the detection device 10 performs a predetermined operation such as participation in the network, control of the detection device 10 itself, transmission of information to the network construction device 20, and the like. In addition, the tag controller 42 can acquire information by reading information from the data storage card 50 in a non-contact manner. Storage of information in the tag part 14 of the detection device 10 and acquisition of information from the data storage card 50 by the tag controller 42 can be executed by holding the mobile terminal 40 over the detection device 10 or the data storage card 50, that is, for example, by bringing the mobile terminal 40 close to the detection device 10 or the data storage card 50 at a predetermined distance (for example, 10 cm). The specific operation for storing information in the tag part 14 of the detection device 10 and acquiring information from the data storage card 50 by the tag controller 42 will be described later with reference to FIG. 2E. The storage unit 43 can store the information read by the tag controller 42. The light emitting unit 44 of the mobile terminal 40 is composed of, for example, a plurality of LEDs, and can emit light in a predetermined color depending on the status of the tag controller 42 or an event under the control of the controller 41. The buzzer 45 of the mobile terminal 40 can output a predetermined sound in accordance with the status of the tag controller 42 or an event under the control of the controller 41. The specific operations of the light emitting unit 44 and the buzzer 45 will be described later with reference to FIGS. 2F to 2H. The battery 46 of the mobile terminal 40 supplies electric power to at least the controller 41 when the mobile terminal 40 is in the power-on status. The electric power may be supplied to the tag controller 42, the storage unit 43, the light emitting unit 44, and the buzzer 45 via, for example, the controller 41, or may be supplied without going through the controller 41.

FIG. 2C is a diagram illustrating an appearance of the mobile terminal 40. The mobile terminal 40 includes a housing 40-1, a slide switch 40-2, and a push switch 40-3, and also an ID light emitting unit 44-1 (an example of a first light emitting unit), a work content light emitting unit 44-2 (an example of the first light emitting unit), and a write status light emitting unit 44-3 (an example of a second light emitting unit), which constitute the light emitting unit 44. The housing 40-1 is formed from an appropriate combination of, for example, a conductive resin and a non-conductive resin, and accommodates each of the above-described units. The slide switch 40-2 is a power switch for switching on/off the power supply of the mobile terminal 40 according to an operator's slide operation. The push switch 40-3 is an active switch capable of switching between the active status and the inactive status of the mobile terminal 40 according to an operator's push operation. The ID light emitting unit 44-1, the work content light emitting unit 44-2, and the write status light emitting unit 44-3 are formed of LEDs arranged in rows in the lateral direction when viewed from the front surface side of the mobile terminal 40. The ID light emitting unit 44-1 can emit light in blue. The work content light emitting unit 44-2 can switch between yellow and cyan (blue-green) to emit light. The write status light emitting unit 44-3 can switch between green and red to emit light. The function of light emitting color of each of the light emitting units 44-1 to 44-3 will be described later.

The data storage card 50 is a so-called non-contact type IC card, includes an IC 51 and an antenna 52, and can store predetermined information in the IC 51 in advance and can communicate with the mobile terminal 40 in a non-contact manner. A plurality of types of data storage cards 50 are used depending on the type of information stored in the IC 51 in advance. Hereinafter, the “data storage card 50” is also referred to as the “work card 50”.

FIG. 2D illustrates an example of the data storage card 50. In the present embodiment, as the plurality of types of data storage cards 50, there are provided a network ID card 50-1 (an example of a first data storage card), an operator ID card 50-2 (an example of a third data storage card), a work content (for installation) card 50-3 (an example of a second data storage card), and a work content (for use) card 50-4 (an example of a fourth data storage card). The network ID card 50-1 stores network information for connecting to the WSN constructed by the network construction device 20 as information. This network information includes a network ID, which is network identification information for identifying the WSN, and a network password for connecting to the WSN identified by this network ID. A plurality of network ID cards 50-1 are prepared as many as WSNs, that is, as many as network construction devices 20. The operator ID card 50-2 stores an operator ID or operator identification information for identifying the operator as information. A plurality of operator ID cards 50-2 are prepared as many as operators. The work content (for installation) card 50-3 stores type information (hereinafter, also simply referred to as the “type of the detection unit 12”) indicating the type of the detection unit 12 connected to the detection device 10 as information. A plurality of work content (for installation) cards 50-3 are prepared as many as types of the detection unit 12 prepared in the plant-equipment status collecting system 1, and include, for example, a “temperature sensor”, a “vibration sensor”, “no sensor (repeater)”, a “general purpose sensor”, and the like. The work content (for use) card 50-4 stores work content information (hereinafter, also simply referred to as the “work contents”) indicating work contents of the operator in equipment check or the like as information. A plurality of work content (for use) cards 50-4 are prepared as many as types of work contents and the like, and include, for example, “no abnormality”, “abnormality (attention)”, “abnormality (warning)”, “repair completed”, and the like. Further, the work contents may include operation contents that change the operation of the detection device 10 after installation, and the operation contents include “stop (automatic restoration disabled)”, “reconnect”, “initialize”, and the like. The work contents are stored as an ID composed of a combination of alphanumeric characters and symbols, for example. In the data storage device 30, for example, correlated data (for example, text data) indicating the work contents is stored in association with this ID. This makes it possible to reduce the load of transmission data, and enhance the degree of freedom of data management on the data storage device 30 end. The aforementioned operator ID is similarly composed of a combination of alphanumeric characters and symbols, and in the data storage device 30, correlated data (for example, text data) indicating the operator is stored in association with the operator ID. The network ID card 50-1, the operator ID card 50-2, the work content (for installation) card 50-3, and the work content (for use) card 50-4 have colors corresponding to their respective types on the exterior part made of resin, paper, or the like. The corresponding colors are provided, for example, by printing. Specifically, the network ID card 50-1 and the operator ID card 50-2 have blue color as their corresponding colors. Hereinafter, the network ID card 50-1 and the operator ID card 50-2 are collectively referred to as “ID cards 50-1 and 50-2”. The work content (for installation) card 50-3 has yellow as its corresponding color. The work content (for use) card 50-4 has cyan (blue-green) as its corresponding color. Besides this, as the data storage card 50, for example, a card for causing the mobile terminal 40 to perform a predetermined operation may be further prepared.

An administrator of the plant can view and edit the plant information (data 002) via 3G/LTE by using a management terminal 70 such as a laptop personal computer connectable to the 3G/LTE. As a result, the administrator can remotely monitor the status of the plant equipment without directly monitoring the plant equipment, and when finding an abnormal condition, the administrator can instruct the operator who carries the mobile terminal 40 to do a repairing work and the like.

The repeater 60 illustrated in FIG. 2A includes a controller 61, a network connection unit 62, a tag part 63, a notification unit 64, and a battery 65. In addition, the repeater 60 may further include a power controller 66. The repeater 60 has an internal structure substantially similar to that of the detection device 10, but differs from the detection device 10 in that it does not have a detection unit.

With reference to FIG. 2E, an example of the operation for storing information in the tag part 14 of the detection device 10 and acquiring information from the data storage card 50 by the tag controller 42 of the mobile terminal 40 will be described. In FIG. 2E, thin arrows in the figure represent signals such as instructions, and bold arrows in the figure represent power supply. The operation of storing the information in the tag part 63 of the relay device 60 by the tag controller 42 of the mobile terminal 40 is also the same, so the description will be omitted.

When the mobile terminal 40 is held over the detection device 10, the tag controller 42 of the mobile terminal 40 transmits, for example, a write signal generated by the tag reader/writer 42-1 with, for example, radio waves or magnetic fields generated by the tag control antenna 42-2 to the detection device 10. In the tag part 14 of the detection device 10, electric power is generated in the tag antenna 14-2 by rectifying radio waves received by the tag antenna 14-2 or by electromagnetic induction by received magnetic fields. The tag antenna 14-2 supplies the generated electric power to the tag IC 14-1, so that the tag IC 14-1 is activated. When a signal included in the radio waves or magnetic fields received by the tag antenna 14-2 is a write signal, the activated tag IC 14-1 stores information included in the write signal.

Thus, when the tag controller 42 of the mobile terminal 40 stores the information in the tag part 14, there is no need to supply electric power from the inside of the detection device 10 to the tag part 14. That is, even when the detection device 10 is in a power-off status or a sleep status, the tag controller 42 of the mobile terminal 40 can store the information in the tag part 14 of the detection device 10.

Further, the tag IC 14-1 activated by the radio waves or the magnetic fields received by the tag antenna 14-2 outputs, for example, a start signal to the power controller 17. When receiving the start signal, the power controller 17 supplies the electric power supplied from the battery 16 to the power controller 17, for example, at least to the controller 11. For example, when the controller 11 to which the electric power is supplied is activated, the detection device 10 enters a power-on status. That is, the detection device 10 is configured to enter a power-on status when information is stored in the tag part 14 by the tag controller 42 of the mobile terminal 40. While the power supply of the detection device 10 is in the power-on status, the controller 11 supplies electric power to the tag IC 14-1 of the tag part 14, so that the controller 11 can store information in the tag IC 14-1 and acquire the information from the tag IC 14-1.

Furthermore, when the detection device 10 in the power-on status enters the power-off status or the sleep status, the controller 11 outputs a stop signal or a sleep signal to the power controller 17. When receiving the stop signal or the sleep signal, the power controller 17, for example, stops the power supply or reduces the amount of power supply to at least the controller 11. For example, when the power supply to the controller 11 is stopped, the detection device 10 enters the power-off status, and when the amount of power supply to the controller 11 is reduced, the detection device enters the sleep status.

On the other hand, when the mobile terminal 40 is held over the data storage card 50, the tag controller 42 of the mobile terminal 40 transmits, for example, a read signal generated by the tag reader/writer 42-1 with, for example, the radio waves or the magnetic fields generated by the tag control antenna 42-2 to the data storage card 50. In the data storage card 50, electric power is generated in the antenna 52 by rectifying radio waves received by the antenna 52 or by electromagnetic induction by received magnetic fields. The antenna 52 supplies the generated electric power to the IC 51, so that the IC 51 is activated. When a signal included in the radio waves or the magnetic fields received by the antenna 52 is a read signal, the activated IC 51 returns the information stored in the IC 51 according to the read signal, with the radio waves or the magnetic fields generated by the antenna 52. The tag controller 42 of the mobile terminal 40 receives the returned radio waves or magnetic fields at the tag control antenna 4-2, and transmits information included in the radio waves or the magnetic fields to the tag reader/writer 42-1. Thus, the information of the data storage card 50 is stored in the tag reader/writer 42-1.

As described above, when the tag controller 42 of the mobile terminal 40 acquires information from the data storage card 50, the operator is not required to perform complicated input operation by manual operation such as using a touch panel type display module. In other words, the tag controller 42 of the mobile terminal 40 can store information necessary for the operation without causing input errors or taking an input confirmation time.

With reference to FIG. 2F, FIG. 2G, and FIG. 2H, examples of a status transition of the mobile terminal 40 and operations of the light emitting unit 44 and the buzzer 45 will be described. FIG. 2F illustrates the status transition of the mobile terminal 40. When an event EV10 of turning on the slide switch 40-2 occurs in a power-off status ST10 of the mobile terminal 40, the mobile terminal 40 turns on the power supply and makes a transition to an inactive status ST20. At this time, the mobile terminal 40 performs an initialization process PC10. In the Initialization process PC10, the light emitting unit 44 is stopped, and the tag controller 42 is stopped after the initialization and a self-diagnosis process for determining whether or not the tag controller 42 functions normally, and then reading information stored in the storage unit 43 and acquired by the tag controller 42 is deleted. The inactive status ST20 is a power saving mode, and is at least for stopping the tag controller 42 and the light emitting unit 44. When an event EV20 of turning on the push switch 40-3 occurs in the inactive status ST20 of the mobile terminal 40, the mobile terminal 40 makes a transition to an active status ST30. At this time, the tag controller 42 of the mobile terminal 40 is activated, and a reading information loading process PC20 for reading the reading information stored in the storage unit 43 is performed. When there is no reading information stored in the storage unit 43, the reading is not performed. Further, when an event EV30 of turning off the slide switch 40-2 occurs in the inactive status ST20 of the mobile terminal 40, the mobile terminal 40 makes a transition to the power-off status ST10. The active status ST30 is a mode in which all the functions of the mobile terminal 40 are executable, and the tag controller 42 and the light emitting unit 44 are activated. The status transition in the active status ST30 will be described later with reference to FIG. 2G. When an event EV40 of turning off the push switch 40-3 occurs in the active status ST30 of the mobile terminal 40, the mobile terminal 40 makes a transition to the inactive status ST20. At this time, the controller 41 performs a reading information saving process PC30 of storing the reading information acquired by the tag controller 42 in the storage unit 33. When an event EV50 of turning off the slide switch 40-2 occurs in the active status ST30 of the mobile terminal 40, the mobile terminal 40 makes a transition to the power-off status ST10.

FIG. 2G illustrates a status transition of the tag controller 42 in the active status ST30 of the mobile terminal 40. FIG. 2H illustrates an example of operations of the light emitting unit 44 and the buzzer 45 according to the status of the tag controller 42 and an event post-process. The tag controller 42 of the mobile terminal 40 makes a transition to statuses ST31 to ST35 described later, according to the presence or absence of the reading information read from the storage unit 33 and its contents. First, when the mobile terminal 40 goes through the initialization process PC10, that is, when the mobile terminal 40 makes a transition to the active status ST30 in the state where there is no reading information in the storage unit 33, the tag controller 42 makes a transition to a standby status ST31 for reading the ID cards 50-1 and 50-2 (hereinafter, also referred to as the ID read standby status).

The ID read standby status ST31 is a status where there is no stored information and only the ID cards 50-1 and 50-2 can be read. In the ID read standby status ST31, the controller 41 causes the ID light emitting unit 44-1 of the light emitting unit 44 to blink in blue (first status). The other work content light emitting unit 44-2 and write status light emitting unit 44-3 are turned off. The blinking of the ID light emitting unit 44-1 in the corresponding color (blue) allows the operator to instantly understand that the ID cards 50-1 and 50-2 are enabled for reading. When an event (hereinafter, also referred to as the network ID read event) EV31-1 for reading the network ID card 50-1 occurs in the ID read standby status ST31, the tag controller 42 acquires the network information and makes a transition to a standby status ST32 for reading the work content (for installation) card 50-3 (hereinafter, also referred to as the work content (for installation) read standby status). At this time, the controller 41 performs a successful reading notification process PC31-1 according to the network ID read event EV31-1. In the successful reading notification process PC31-1, under the control of the controller 41, the ID light emitting unit 44-1 and the work content light emitting unit 44-2 perform operations depending on the status (in this case, the ID light emitting unit 44-1 blinks in blue and the work content light emitting unit 44-2 is turned off), the write status light emitting unit 44-3 is turned on in green for a fixed time, and the buzzer 45 outputs a sound of “beep!”. The sound of the buzzer 45 and the turning-on of the write status light emitting unit 44-3 allow the operator to instantly understand that the network ID card 50-1 is read successfully. Further, when an event (hereinafter, also referred to as the operator ID read event) EV31-2 for reading the operator ID card 50-2 occurs in the ID read standby status ST31, the tag controller 42 acquires the operator ID and makes a transition to a standby status ST33 for reading the work content (for use) card 50-4 (hereinafter, also referred to as the work content (for use) read standby status). At this time, the controller 41 performs a successful reading notification process PC31-2 according to the operator ID read event EV31-2. The successful reading notification process PC31-2 is the same as the aforementioned successful reading notification process PC31-1.

The work content (for installation) read standby status ST32 is a status where reading of the network ID card 50-1 is finished and only the work content (for installation) card 50-3 is enabled for reading. In the work content (for installation) read standby status ST32, of the light emitting unit 44, the controller 41 turns on the ID light emitting unit 44-1 of the light emitting unit 44 in blue (second status), and blinks the work content light emitting unit 44-2 in yellow. The write status light emitting unit 44-3 is turned off. The turning-on of the ID light emitting unit 44-1 in the corresponding color (blue) and the blinking of the work content light emitting unit 44-2 in the corresponding color (yellow) allow the operator to instantly understand that reading of the network ID card 50-1 is finished and the work content (for installation) card 50-3 is now waiting for reading. When an event EV32-1 (hereinafter, also referred to as the work content (for installation) read event) for reading the work content (for installation) card 50-3 occurs in the work content (for installation) read standby status ST32, the tag controller 42 acquires the type of the detection unit 12 and makes a transition to a standby status ST34 for writing the network information and the type of the detection unit 12 (hereinafter, also referred to as the installation information) to the detection device 10 (hereinafter, also referred to as the installation information write standby status). At this time, the controller 41 performs a successful reading notification process PC32-1 according to the work content (for installation) read event EV32-1. In the successful reading notification process PC32-1, under the control of the controller 41, the ID light emitting unit 44-1 and the work content light emitting unit 44-2 perform operations depending on the status (in this case, the ID light emitting unit 44-1 is turned on in blue and the work content light emitting unit 44-2 blinks in yellow), the write status light emitting unit 44-3 is turned on in green for a fixed time, and the buzzer 45 outputs a sound of “beep!”. Further, when an operator ID read event EV32-2 occurs in the work content (for installation) read standby status ST32, the tag controller 42 acquires the operator ID and makes a transition to the work content (for use) read standby status ST33. At this time, the network information stored in the tag controller 42 is erased. That is, only one of the network information and the operator ID can be stored in the tag controller 42. Further, at this time, the controller 41 performs a successful reading notification process PC32-2 according to the operator ID read event EV32-2. The successful reading notification process PC32-2 is the same as the aforementioned successful reading notification process PC32-1. Further, when a network ID read event EV32-3 occurs in the work content (for installation) read standby status ST32, the tag controller 42 acquires and updates the network information, and then makes a transition to the work content (for installation) read standby status ST32 again. At this time, the controller 41 performs a successful reading notification process PC32-3 according to the network ID read event EV32-3. The successful reading notification process PC32-3 is the same as the aforementioned successful reading notification process PC32-1.

The work content (for use) read standby status ST33 is a status where reading of the operator ID card 50-2 is finished and only the work content (for use) card 50-4 is enabled for reading. In the work content (for use) read standby status ST33, of the light emitting unit 44, the controller 41 turns on the ID light emitting unit 44-1 in blue, and blinks the work content light emitting unit 44-2 in cyan. The write status light emitting unit 44-3 is turned off. The turning-on of the ID light emitting unit 44-1 in the corresponding color (blue) and the blinking of the work content light emitting unit 44-2 in the corresponding color (cyan) allow the operator to instantly understand that reading of the operator ID card 50-2 is finished and the work content (for use) card 50-4 is now waiting for reading. When an event EV33-1 (hereinafter, also referred to as the work content (for use) read event) for reading the work content (for use) card 50-4 occurs in the work content (for use) read standby status ST33, the tag controller 42 acquires the work contents or the operation contents and makes a transition to a standby status ST35 for writing the operator ID, the work contents, and the like (hereinafter, also referred to as the use information) to the detection device 10 (hereinafter, also referred to as the use information write standby status). At this time, the controller 41 performs a successful reading notification process PC33-1 according to the work content (for use) read event EV33-1. In the successful reading notification process PC33-1, under the control of the controller 41, the ID light emitting unit 44-1 and the work content light emitting unit 44-2 perform operations depending on the status of the tag controller 42 (in this case, the ID light emitting unit 44-1 is turned on in blue and the work content light emitting unit 44-2 blinks in cyan), the write status light emitting unit 44-3 is turned on in green for a fixed time, and the buzzer 45 outputs a sound of “beep!”. Further, when a network ID read event EV33-2 occurs in the work content (for use) read standby status ST33, the tag controller 42 acquires the network information, and then makes a transition to the work content (for installation) read standby status ST32. At this time, the operator ID stored in the tag controller 42 is erased. Further, at this time, the controller 41 performs a successful reading notification process PC33-2 according to the network ID read event EV33-2. The successful reading notification process PC33-2 is the same as the aforementioned successful reading notification process PC33-1. Further, when an operator ID read event EV33-3 occurs in the work content (for use) read standby status ST33, the tag controller 42 acquires and updates the operator ID, and then makes a transition to the work content (for use) read standby status ST33 again. At this time, the controller 41 performs a successful reading notification process PC33-3 according to the operator ID read event EV33-3. The successful reading notification process PC33-3 is the same as the aforementioned successful reading notification process PC33-1.

The installation information write standby status ST34 is a status where reading of the network ID card 50-1 and the work content (for installation) card 50-3 is finished and the installation information is enabled for writing to the detection device 10. In the installation information write standby status ST34, of the light emitting unit 44, the controller 41 turns on the ID light emitting unit 44-1 in blue, turns on the work content light emitting unit 44-2 in yellow, and blinks the write status light emitting unit 44-3 in green. The turning-on of the ID light emitting unit 44-1 and the work content light emitting unit 44-2 in the corresponding colors (blue and yellow) and the blinking of the write status light emitting unit 44-3 in green allow the operator to instantly understand that reading of the network ID card 50-1 and the work content (for installation) card 50-3 is finished and the installation information is now waiting for writing to the detection device 10. When an event EV34-1 (hereinafter, also referred to as the installation information write event) for writing the installation information to the detection device 10 occurs in the installation information write standby status ST34, the tag controller 42 makes a transition to the installation information write standby status ST34 again while holding the installation information. Thus, the installation information can be written to the detection device 10 continuously. At this time, the controller 41 performs a successful writing notification process PC34-1 according to the installation information write event EV34-1. In the successful writing notification process PC34-1, under the control of the controller 41, the ID light emitting unit 44-1 and the work content light emitting unit 44-2 perform operations depending on the status of the tag controller 42 (in this case, the ID light emitting unit 44-1 is turned on in blue, and the work content light emitting unit 44-2 is turned on in yellow), the write status light emitting unit 44-3 is turned on in green for a fixed time, and the buzzer 45 outputs a sound of “beep! beep!”. Further, when a work content (for installation) read event EV34-2 occurs in the installation information write standby status ST34, the tag controller 42 acquires and updates the type of the detection unit 12, and then makes a transition to the installation information write standby status ST34 again. Thus, it is possible to change the type of the detection unit 12 while holding the same network information and to write the installation information to the detection device 10. At this time, the controller 41 performs a successful reading notification process PC34-2 according to the work content (for installation) read event EV34-2. In the successful reading notification process PC34-2, under the control of the controller 41, the ID light emitting unit 44-1 and the work content light emitting unit 44-2 perform operations depending on the status (in this case, the ID light emitting unit 44-1 is turned on in blue and the work content light emitting unit 44-2 is turned on in yellow), the write status light emitting unit 44-3 is turned on in green for a fixed time, and the buzzer 45 outputs a sound of “beep!”.

The use information write standby status ST35 is a status where reading of the operator ID card 50-2 and the work content (for use) card 50-3 is finished and the use information is enabled for writing to the detection device 10. In the use information write standby status ST35, of the light emitting unit 44, the controller 41 turns on the ID light emitting unit 44-1 in blue, turns on the work content light emitting unit 44-2 in cyan, and blinks the write status light emitting unit 44-3 in green. The turning-on of the ID light emitting unit 44-1 and the work content light emitting unit 44-2 in the corresponding colors (blue and cyan) and the blinking of the write status light emitting unit 44-3 in green allow the operator to instantly understand that reading of the operator ID card 50-2 and the work content (for use) card 50-4 is finished and the use information is now waiting for writing to the detection device 10. When an event EV35-1 (hereinafter, also referred to as the use information write event) for writing the installation information to the detection device 10 occurs in the use information write standby status ST35, the tag controller 42 makes a transition to the use information write standby status ST35 again while holding the use information. Thus, the use information can be written to the detection device 10 continuously. At this time, the controller 41 performs a successful writing notification process PC35-1 according to the use information write event EV35-1. In the successful writing notification process PC35-1, under the control of the controller 41, the ID light emitting unit 44-1 and the work content light emitting unit 44-2 perform operations depending on the status of the tag controller 42 (in this case, the ID light emitting unit 44-1 is turned on in blue, and the work content light emitting unit 44-2 is turned on in cyan), the write status light emitting unit 44-3 is turned on in green for a fixed time, and the buzzer 45 outputs a “beep! beep!” sound. Further, when a work content (for use) read event EV35-2 occurs in the use information write standby status ST35, the tag controller 42 acquires and updates the work contents and the like, and then makes a transition to the use information write standby status ST35 again. Thus, it is possible to change the work contents and the like while holding the same operator ID and to write the use information to the detection device 10. At this time, the controller 41 performs a successful reading notification process PC35-2 according to the work content (for use) read event EV35-2. In the successful reading notification process PC35-2, under the control of the controller 41, the ID light emitting unit 44-1 and the work content light emitting unit 44-2 perform operations depending on the status of the tag controller 42 (in this case, the ID light emitting unit 44-1 is turned on in blue and the work content light emitting unit 44-2 is turned on in cyan), the write status light emitting unit 44-3 is turned on in green for a fixed time, and the buzzer 45 outputs a sound of “beep!”.

Further, when an event of reading from the data storage card 50 or an event for writing to the detection device 10 occurs except for the above-mentioned conditions, or when the reading or writing fails, the controller 41 performs an error notification process. In this error notification process, under the control of the controller 41, the ID light emitting unit 44-1 and the work content light emitting unit 44-2 perform operations depending on the status of the tag controller 42, the light emitting unit 44-3 is tuned on in red for a fixed time, and the buzzer 45 outputs a sound of “beeeeep!”. The alarm color (red), which is different from the corresponding colors (blue, yellow, cyan) of the write status light emitting unit 44-3 and the notifying color (green) for successful reading/writing, and the warning sound of the buzzer 45 allow the operator to instantly understand that an error occurs.

Further, in the initialization process PC10 in FIG. 2F, when the self diagnosis results in an error (not in a normal status), the controller 11 executes a self diagnosis error process according to the result. In the self diagnosis error process, under the control of the controller 41, the ID light emitting unit 44-1 and the work content light emitting unit 44-2 are turned off, the write status light emitting unit 44-3 blinks in red, and the buzzer 45 outputs a sound of “beeeep! beeeep! beeeep!”. The warning sound of the buzzer 45 allows the operator to instantly understand that a self-diagnosis error occurs.

Further, when the mobile terminal 40 enters the active status ST30 without going through the initialization processing PC10, that is, with the storage unit 33 holding the reading information, the tag controller 42 makes a transition to one of the statuses ST33 to ST35 depending on the type of the reading information read from the storage unit 33. Specifically, for example, when the reading information indicates only the network information, the tag controller 42 makes a transition to the work content (for installation) read standby status ST32. Further, for example, when the reading information indicates only the operator ID, the tag controller 42 makes a transition to the work content (for use) read standby status ST33. Further, for example, when the reading information indicates the network information and the type of the detection unit 12, the tag controller 42 makes a transition to the installation information write standby status ST34. Further, for example, when the reading information indicates the operator ID, the work contents, and the like, the tag controller 42 makes a transition to the use information write standby status ST35.

«2. Operation of Plant-Equipment Status Collecting System»

«2-1. Collection of Statuses of Plant Equipment»

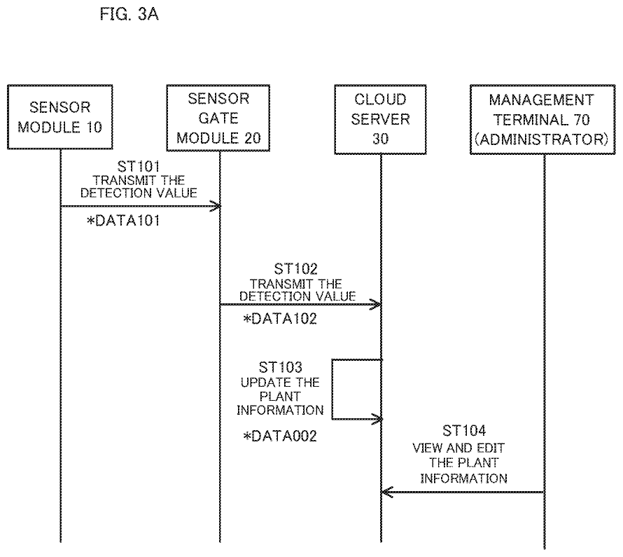

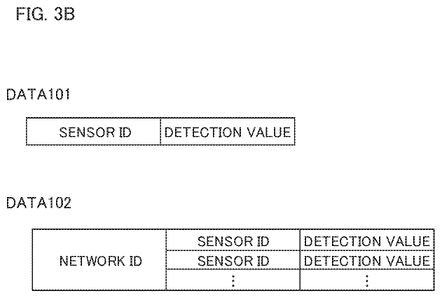

With reference to FIG. 3A and FIG. 3B, an example of the operation of the plant-equipment status collecting system 1 to collect the statuses of plant equipment will be described. Here, it is assumed that the sensor module 10 is connected to a WSN constructed by the sensor gate module 20. Connection of the sensor module 10 to the WSN constructed by the sensor gate module 20 will be described in «2-2. Attachment of detection device (sensor module)».

In step ST101, the sensor module 10 detects a status of the plant equipment to which the sensor module 10 is attached, for a detection item for each set detection interval, and transmits the detection value together with its own sensor ID to the sensor gate module 20. That is, the data transmitted in step ST101 is data 101 illustrated in FIG. 3B.

In step ST102, the sensor gate module 20 transmits the received sensor ID and detection value together with the network ID of the WSN constructed by the sensor gate module 20 itself to the cloud server 30 via the 3G/LTE. That is, the data transmitted in step ST102 is data 102 illustrated in FIG. 3B.

Here, in step ST102, each time the sensor gate module 20 receives a detection value from any one of the sensor modules 10 connected to the WSN constructed by the sensor gate module 20 itself, the sensor gate module 20 may transmit the sensor ID and the detection value together with the network ID. Alternatively, in step ST102, the sensor gate module 20 may temporarily store the received sensor ID and detection value so that the sensor gate module 20 can transmit a plurality of sensor IDs and detection values temporarily stored for each set transmission interval together with the network ID.

In step ST103, the cloud server 30 reflects the received data 102 on the plant information (data 002) stored in the storage unit 33 of the cloud server 30 and thus updates the plant information (data 002). Step ST101, step ST102, and step ST103 are repeated at any time.

In the plant-equipment status collecting system 1, the status of the plant equipment detected by the sensor module 10 is automatically reflected on the plant information (data 002) stored in the cloud server 30. As a result, every time the operator detects or confirms the status of the plant equipment, it is not necessary for the operator to move to the position where the target plant equipment is located. Further, as in step ST104, the administrator can view and edit the status of the plant equipment by remotely using the management terminal 70.

«2-2. Attachment of Detection Device (Sensor Module)»

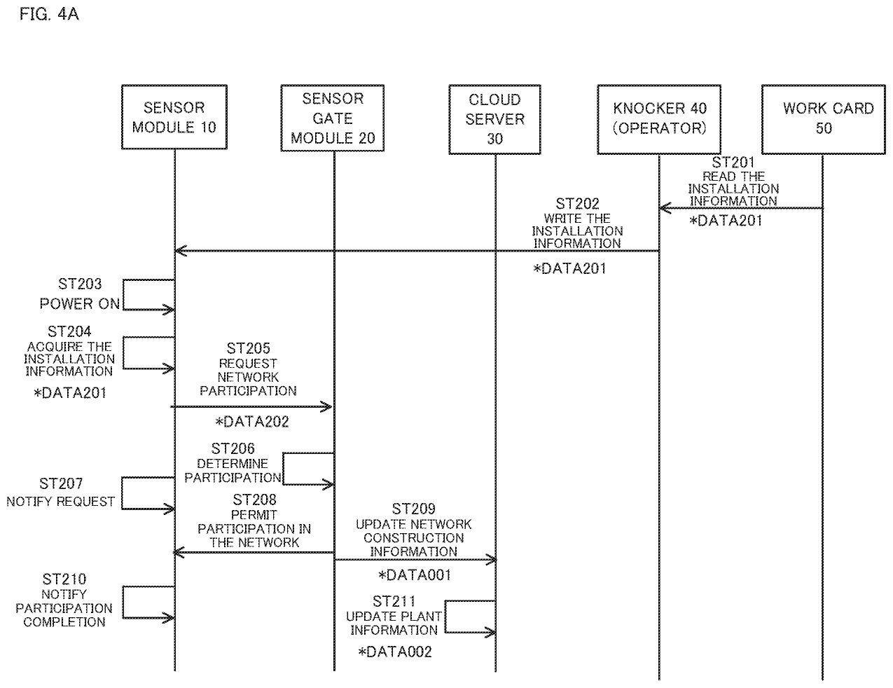

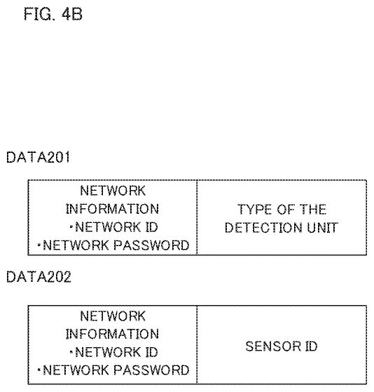

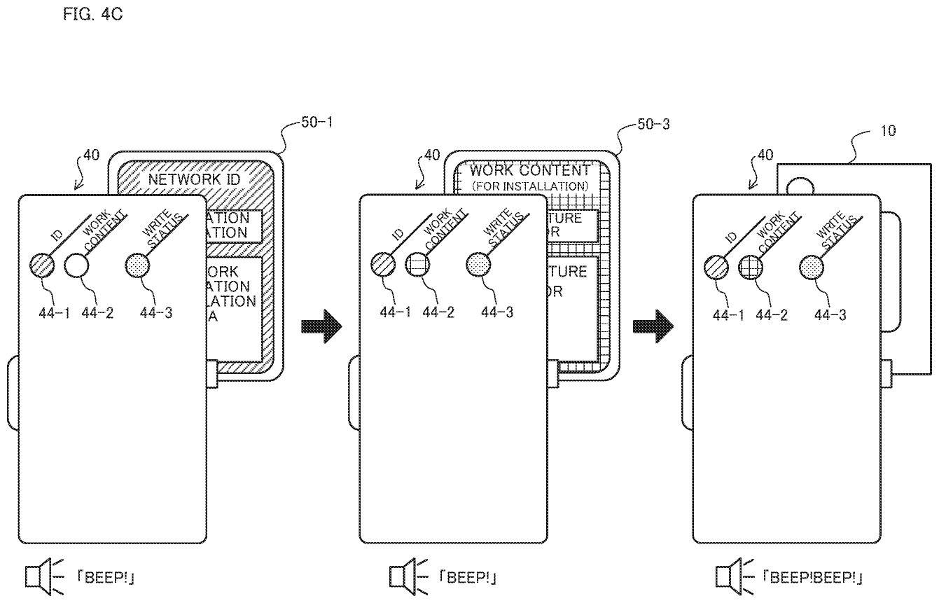

With reference to FIG. 4A, FIG. 4B, and FIG. 4C, an example of work of attaching (newly installing and exchanging) the sensor module 10 to the plant equipment will be described. When the operator attaches the sensor module 10 to the plant equipment, the work of attaching the sensor module 10 to the plant equipment proceeds to step ST201. At the time when the operator attaches the sensor module 10 to the plant equipment, the sensor module 10 is, for example, in a power-off status (including a pause status) or a sleep status.

In step ST201, the operator causes the knocker 40 to read the installation information related to the sensor module 10 from the work card 50. The data acquired in step ST201 is data 201 illustrated in FIG. 4B. That is, the data 201 acquired in step ST201 includes network information for connecting the sensor module 10 to the WSN constructed by the sensor gate module 20 and the type of the detection unit 12.

The network information of the data 201 includes a network ID and a network password for connecting to the WSN identified by the network ID.

For example, in the sensor module 10, predetermined operation conditions (detection items and an initial value of detection interval) are set depending on the type of the detection unit 12 in the data 201. As the types of the detection unit 12, for example, if the plant equipment to which the sensor module 10 is attached is a steam trap, a temperature sensor is selected; if the plant equipment to which the sensor module 10 is attached is a rotating machine, a temperature sensor and a vibration sensor are selected.

FIG. 4C illustrates an example of installation information reading work using the knocker 40. The operator first acquires the network information by holding the knocker 40 in the active status ST30 over any network ID card 50-1, and then acquires the type of the detection unit 12 by holding the knocker 40 over any work content (for installation) card 50-3. At this time, if the slide switch 40-2 is first turned on, the status of the tag controller 42 of the knocker 40, the event, and the process after the event are caused in the following order: the ID read standby status ST31, the network ID read event EV31-1, the successful reading notification process PC31-1, the work content (for installation) read standby status ST32, the work content (for installation) read event EV32-1, the successful reading notification process PC32-1, and the installation information write standby status ST34. The operations of the light emitting unit 44 and the buzzer 45 according to this are performed in the following order: blinking of the ID light emitting unit 44-1 in blue, temporarily turning-on of the write status light emitting unit 44-3 in green and output of a sound of “beep!” from the buzzer 45, turning-on of the ID light emitting unit 44-1 in blue and blinking of the work content light emitting unit 44-2 in yellow, temporarily turning-on of the write status light emitting unit 44-3 in green and output of a sound of “beep!” from the buzzer 45, turning-on of the ID light emitting unit 44-1 in blue, and turning-on of the work content light emitting unit 44-2 in yellow and blinking of the write status light emitting unit 44-3 in green. Thus, the operations of the light emitting unit 44 and the buzzer 45 allow instant understanding of the contents and order of the information to be read, and makes it possible to easily acquire the network information and the type of the detection unit 12.

In step ST202, the operator holds the knocker 40 over the sensor module 10, so that the installation information stored in the knocker 40 is automatically stored in the tag part 14 of the sensor module 10. In step ST202, the installation information stored in the tag part 14 of the sensor module 10 is the data 201.

FIG. 4C illustrates an example of installation information writing work using the knocker 40. The operator holds the knocker 40 over the sensor module 10 to write the installation information to the tag part 14 of the sensor module 10. At this time, the status of the tag controller 42 of the knocker 40, the event, and the process after the event are caused in the following order: the installation information write standby status ST34, the installation information write event EV34-1, and the successful writing notification process PC34-1. The operations of the light emitting unit 44 and the buzzer 45 according to this are performed in the following order: turning-on of the ID light emitting unit 44-1, turning-on of the work content light emitting unit 44-2 in yellow and blinking of the write status light emitting unit 44-3 in green, and temporarily turning-on of the write status light emitting unit 44-3 and output of a sound of “beep! beep!” from the buzzer 45. Thus, the operations of the light emitting unit 44 and the buzzer 45 allow the operator to instantly understand the success or failure of writing information to the sensor module 10.

In step ST203, the sensor module 10 is powered on when the data 201 is stored in step ST202. When the sensor module 10 is powered on, the process proceeds to step ST204. In step ST204, the controller 11 of the sensor module 10 acquires the data 201 stored in the tag part 14.

In step ST205, the sensor module 10 transmits a network participation request to the sensor gate module 20. The data transmitted in the network participation request in step ST205 is data 202 including the sensor ID and the network information illustrated in FIG. 4B.

In step ST206, when receiving the network participation request, the sensor gate module 20 determines whether or not to permit the sensor module 10 having transmitted the network participation request to participate in the network. That is, the sensor gate module 20 determines whether or not the network ID and the network password in the network information included in the network participation request match the network ID and the network password of the WSN constructed by the sensor gate module 20 itself. If the network ID and the network password in the network information included in the network participation request match the network ID and the network password of the WSN constructed by the sensor gate module 20 itself, then the process proceeds to step ST208. On the other hand, if the network ID and the network password in the network information included in the network participation request do not match the network ID and the network password of the WSN constructed by the sensor gate module 20 itself, then step ST208, step ST209, step ST210, and step ST211 are not executed and accordingly the process ends.

In step ST207, the sensor module 10 notifies that network participation is being requested after the sensor module 10 transmits the network participation request in step ST205. For example, when the notification unit 15 of the sensor module 10 includes an LED, the controller 11 of the sensor module 10, for example, blinks the LED to notify that network participation is being requested. The operator visually recognizes that the LED is blinking, for example, and can thus recognize that the network participation request has been transmitted from the sensor module 10.

In step ST208, the sensor gate module 20 permits the sensor module 10 to participate in the network, and causes the sensor module 10 to connect to the WSN constructed by the sensor gate module 20 itself. In step ST209, the sensor gate module 20 adds the sensor ID and the connection status of the sensor module 10 permitted to participate in the network in step ST208 to the network construction information (data 001), and transmits the resulting information to the cloud server 30.

In step ST210, the sensor module 10 notifies that the participation in the network is completed. For example, the controller 11 of the sensor module 10 turns off the LED blinked in step ST207 to notify that the participation in the network is completed. The operator visually recognizes that the LED is turned off, for example, and can thus recognize that the connection of the sensor module 10 to the WSN is completed.

In step ST211, the cloud server 30 reflects the data 001 received in step ST211 on the plant information (data 002) stored in the storage unit 33 of the cloud server 30. This makes it possible to view information on the sensor module 10 having completed to participate in the network. The administrator can confirm the plant information (data 002) stored in the storage unit 33 of the cloud server 30 by using the management terminal 70. Further, the operator can perform operation of attaching another sensor module 10 to the plant equipment by using the installation information stored in the knocker 40. Further, the sensor module 10 sets its own detection item and detection interval according to the type of the detection unit 12 acquired from the knocker 40.

The plant-equipment status collecting system 1 can readily acquire the network information including the network ID and the type of the detection unit 12 by holding the knocker 40 over the network ID card 50-1 and the work content (for installation) card 50-3, and can automatically set the network information and the type of the detection unit 12 stored in the knocker 40 in the sensor module 10 by further holding the knocker 40 over the sensor module 10. That is, for example, it is not necessary to perform complicated input operations for manually inputting information like a tablet terminal. Therefore, by simplifying information acquiring work with respect to the knocker 40, the work of installing the sensor module 10 can be simplified.

Further, it is not necessary for the plant-equipment status collecting system 1 to include, for example, a display unit and an input unit for manual input, such as a touch panel type display module, in the knocker 40. Therefore, as compared with the case where the knocker 40 includes the display unit and the input unit, a structure for explosion-proof, dust-proof, and/or waterproofing can be easily achieved.

In the plant-equipment status collecting system 1, when the installation information input to the knocker 40 is stored in the tag part 14 of the sensor module 10, the sensor module 10 enters a power-on status. Therefore, even if a period of standby time from when the sensor module 10 is attached to the plant equipment to when the sensor module 10 is connected to the network becomes long, it is not necessary for the sensor module 10 to wait in the power-on status, and thus the consumption of the battery can be reduced. Furthermore, since it is not necessary for the operator to operate a power switch of the sensor module 10 or the like to bring the sensor module 10 to the power-on status, the work of attaching the sensor module 10 to the plant equipment can be simplified.

«2-3. Attachment of Repeater»

The work of attaching the repeater 60 in the plant is, for example, work to be done if the sensor module 10 attached to the plant equipment is not connected to the WSN even when a sufficient time has passed after step ST202 of «2-2. Attachment of detection device (sensor module)». An example of the work of attaching the repeater 60 in the plant is substantially the same as the work described in «2-2. Attachment of detection device (sensor module)». It differs from the attaching work of the sensor module 10 in that since the repeater 60 does not include the detection unit 12, information of “no sensor” is acquired from the work content (for installation) card 50-3 in which the information of “no sensor” is stored as the type of the detection unit 12 when the knocker 40 acquires the installation information in step ST201.

As described above, the work of attaching the repeater 60 in the plant is substantially the same as the work described in «2-2. Attachment of detection device (sensor module)». Therefore, also on the work of attaching the repeater 60 in the plant, it has advantageous effects equivalent to the advantageous effects described in «2-2. Attachment of detection device (sensor module)». As a result, in the plant-equipment status collecting system 1, the work of attaching the repeater 60 in the plant is simplified.

«2-4. Transmission of Work Contents»

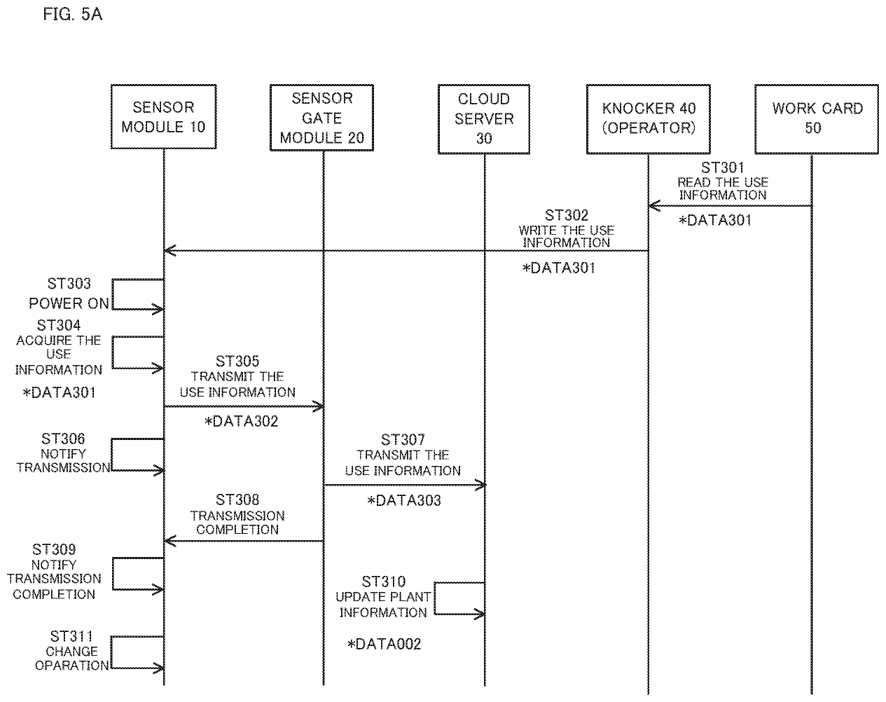

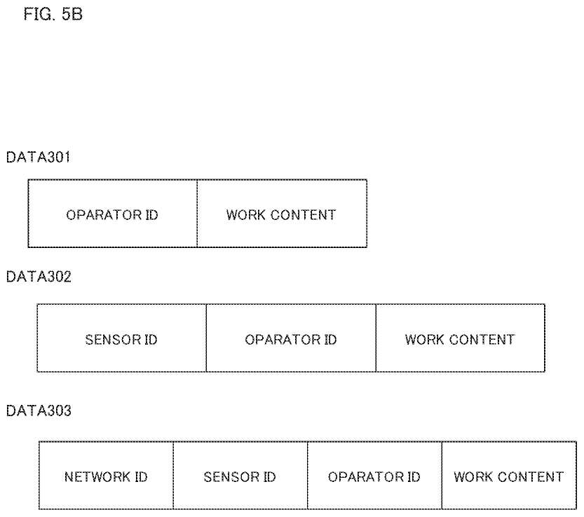

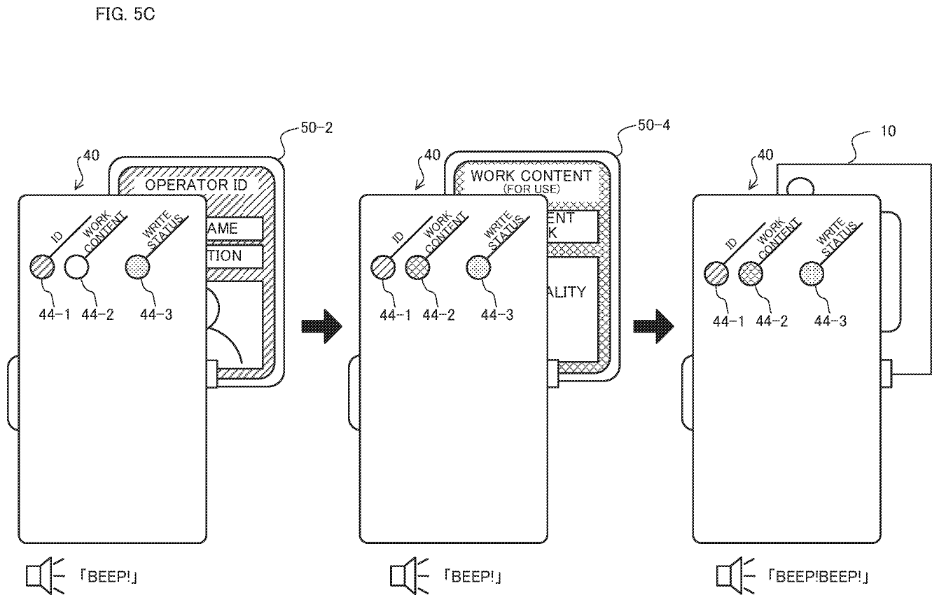

With reference to FIG. 5A, FIG. 5B, and FIG. 5C, an example of an operation when operator's work contents are transmitted will be described. The following example shows a case where the plant equipment is periodically inspected during use of the plant-equipment status collecting system 1. Besides this, a work timing of the operator is, for example, for repairing the plant equipment, for changing the operation of the sensor module 10, or the like, in response to the status of the plant equipment indicating an abnormal status. That is, transmission of the work contents is performed after the operator does work or concurrently with the work.

In step ST301, the operator causes the knocker 40 to read the use information related to his or her work contents from the work card 50. The data acquired in step ST301 is data 301 illustrated in FIG. 5B. That is, the data 301 acquired in step ST301 includes his or her operator ID and work contents.

The work contents in the data 301 are appropriately selected according to the work having been done or to be done by the operator. For example, if there is no abnormality in the plant equipment during periodic inspection, “no abnormality” is selected as the work contents. If there is an abnormality, “abnormality (attention level)”, “abnormality (warning level)”, or the like is selected as appropriate. If the plant equipment has been repaired, “repair completed” is selected as the work contents. If the operation of the plant equipment is changed, “stop (automatic restoration disabled)”, “reconnect”, “initialize”, or the like is selected as appropriate.

FIG. 5C illustrates an example of use information reading work using the knocker 40. The operator first holds the knocker 40 over his or her operator ID card 50-2 to acquire the operator ID, and then holds the knocker 40 over any work content (for use) card 50-4 to acquire the work contents. At this time, if the slide switch 40-2 is first turned on, the status of the tag controller 42 of the knocker 40, the event, and the process after the event are caused in the following order: the ID read standby status ST31, the operator ID read event EV31-2, the successful reading notification process PC31-2, the work content (for use) read standby status ST33, the work content (for use) read event EV33-1, the successful reading notification process PC33-1, and the use information write standby status ST35. The operations of the light emitting unit 44 and the buzzer 45 according to this are performed in the following order: blinking of the ID light emitting unit 44-1 in blue, temporarily turning-on of the write status light emitting unit 44-3 in green and output of a sound of “beep!” from the buzzer 45, turning-on of the ID light emitting unit 44-1 in blue and blinking of the work content light emitting unit 44-2 in cyan, temporarily turning-on of the write status light emitting unit 44-3 in green and output of a sound of “beep!” from the buzzer 45, turning-on of the ID light emitting unit 44-1 in blue, and turning-on of the work content light emitting unit 44-2 in cyan and blinking of the write status light emitting unit 44-3 in green. Thus, the operations of the light emitting unit 44 and the buzzer allow instant understanding of the contents and order of the information to be read, and makes it possible to easily acquire the network information and the type of the detection unit 12.

In step ST302, the operator holds the knocker 40 over the sensor module 10, so that the use information stored in the knocker 40 is automatically stored in the tag part 14 of the sensor module 10. In step ST302, the use information stored in the tag part 14 of the sensor module 10 is the data 301.

FIG. 5C illustrates an example of use information writing work using the knocker 40. The operator holds the knocker 40 over the sensor module 10 to write the use information to the tag part 14 of the sensor module 10. At this time, the status of the tag controller 42 of the knocker 40, the event, and the process after the event are caused in the following order: the use information write standby status ST35, the use information write event EV35-1, and the successful writing notification process PC35-1. The operations of the light emitting unit 44 and the buzzer 45 according to this are performed in the following order: turning-on of the ID light emitting unit 44-1, turning-on of the work content light emitting unit 44-2 in cyan and blinking of the write status light emitting unit 44-3 in green, and temporarily turning-on of the write status light emitting unit 44-3 and output of a sound of “beep! beep!” from the buzzer 45. Thus, the operations of the light emitting unit 44 and the buzzer 45 allow the operator to instantly understand the success or failure of writing information to the sensor module 10.

In step ST303, the sensor module 10 is powered on when the data 301 is stored in step ST302. When the sensor module 10 is powered on, the process proceeds to step ST304. In step ST304, the controller 11 of the sensor module 10 acquires the data 301 stored in the tag part 14.

In step ST305, the sensor module 10 transmits the use information to the sensor gate module 20. The data transmitted in step ST305 is data 302 including the sensor ID, the operator ID and the work contents illustrated in FIG. 5B. In step ST306, the sensor module 10 notifies that the use information is being transmitted after the sensor module 10 transmits the use information in step ST305. For example, when the notification unit 15 of the sensor module 10 includes an LED, the controller 11 of the sensor module 10, for example, blinks the LED to notify that use information is being transmitted. The operator visually recognizes that the LED is blinking, for example, and can thus recognize that the use information has been transmitted from the sensor module 10.

In step ST307, the sensor gate module 20 transmits the use information received from the sensor module 10 to the cloud server 30. The data transmitted in step S307 is data 303 including the network ID, the sensor ID, the operator ID, and the work contents illustrated in FIG. 5B. In step S308, the sensor gate module 20 transmits use information transmission completion information to the sensor module 10.

In step S309, the sensor module 10 notifies that the transmission of the use information is completed. For example, the controller 11 of the sensor module 10 turns off the LED blinked in step ST306 to notify that the transmission of the use information is completed. The operator visually recognizes that the LED is turned off, for example, and can thus recognize that the transmission of the use information to the cloud server 30 is completed.

In step ST310, the cloud server 30 reflects the use information received in step ST307 on the plant information (data 002) stored in the storage unit 33 of the cloud server 30. This allows the operator to view the information on the work contents. The administrator can confirm the plant information (data 002) stored in the storage unit 33 of the cloud server 30 by using the management terminal 70 to confirm the work contents of the operator. Further, the operator can transmit the work contents after performing further work or concurrently with the work via another sensor module 10 by using the use information stored in the knocker 40.

In step ST311, if the use information includes contents of operation of changing the operation of the sensor module 10, the sensor module 10 changes the operation according to this information. If the use information does not include contents of operation of the sensor module 10, step ST306 is not performed.

The plant-equipment status collecting system 1 can readily acquire the operator ID and the work contents by holding the knocker 40 over the operator ID card 50-2 and the work content (for use) card 50-4, and can transmit the operator ID and the work contents stored in the knocker 40 to the cloud server 30 via the sensor module 10 by further holding the knocker 40 over the sensor module 10. That is, for example, it is not necessary to perform complicated input operations for manually inputting information like a tablet terminal. Therefore, by simplifying information acquiring work with respect to the knocker 40, the work of reporting the work contents can be simplified.

As described above, according to the plant-equipment status collecting system 1 of the present embodiment, it is possible to simplify work related to installation of the detection device 10 that detects the status of the predetermined measured object (plant equipment) and/or work related to reporting the work contents of the operator. These actions and advantageous effects can be achieved by the following configuration.

The plant-equipment status collecting system 1 includes the detection device 10, the network construction device 20, the data storage device 30, the data storage card 50, and the mobile terminal 40, wherein

the detection device 10 includes the detection unit 12 configured to detect a status of a predetermined measured object and the tag part 14 configured to store predetermined information in a non-contact manner, and to transmit at least the status detected by the detection unit 12 and detection device identification information (sensor ID) for identifying the detection device 10 to the network construction device 20 through the network constructed by the network construction device 20,

the data storage device 30 includes the storage unit 33 configured to store at least the status and the detection device identification information received from the network construction device 20,

the data storage card 50 stores the information and is communicatable with the mobile terminal 40 in a non-contact manner,

the mobile terminal 40 includes the tag controller 42 configured to automatically read the information from the data storage card 50 in a non-contact manner and to automatically store the information read in the tag part 14 of the detection device 10 in a non-contact manner, and

the detection device 10 performs a predetermined operation when the information is stored in the tag part 14.

Further, the data storage card 50 includes at least a first data storage card (network ID card 50-1) for storing network information including network identification information (network ID) for connecting to the network as the information,

the detection device 10 transmits at least the network identification information to the network construction device 20 when the network information is stored in the tag part 14, and

the network construction device 20 determines whether or not to permit the detection device 10 to connect to the network by using the network identification information.

In addition, the data storage card 50 further includes a second data storage card (work content (for installation) card 50-3) for storing type information indicating a type of the detection unit 12 as the information,

the tag controller 42 of the mobile terminal 40 can automatically read the type information from the second data storage card after automatically reading the network information from the first data storage card in a non-contact manner, and automatically store the network information and type information read in the tag part 14 of the detection device 10 in a non-contact manner, and

the detection device 10 transmits the status detected by the detection unit 12 corresponding to the type information stored in the tag part 14 and the detection device identification information to the network construction device 20 via the network.

The data storage card 50 further includes a third data storage card (operator ID card 50-2) for storing operator identification information (operator ID) for identifying the operator as the information, and a fourth data storage card (work content (for installation) card 50-4) for storing work content information indicating work contents of the operator as the information,

the tag controller 42 of the mobile terminal 40 can automatically read the operator identification information from the third data storage card in a non-contact manner, read the work content information from the fourth data storage card after reading the operator identification information, and automatically store the operator identification information and work content information read in the tag part 14 of the detection device 10 in a non-contact manner,

the detection device 10 transmits the operator identification information and the work content information stored in the tag part 14 and the detection device identification information to the network construction device 20 via the network, and

the data storage device 30 stores the operator identification information, the work content information, and the detection device identification information received from the network construction device 20, into the storage unit 33.

In addition, the data storage card 50 may store first password information, and permit the tag controller 42 of the mobile terminal 40 to read the information when the tag controller 42 of the mobile terminal 40 is authenticated with the first password information. Specifically, the first password information is stored in advance in the IC 51 of the data storage card 50 and the tag controller 42 of the mobile terminal 40, and the first password is transmitted together with a read signal from the tag controller 42 of the mobile terminal 40 to the data storage card 50. If the received first password matches the first password stored in the IC 51 of the data storage card 50, the IC 51 of the data storage card 50 transmits the information stored therein to the tag controller 42 of the mobile terminal 40. Thus, it is possible to restrict reading of information from devices other than the predetermined mobile terminal 40, and to prevent leakage of the information.

In addition, the tag part 14 of the detection device 10 may store second password information, and permit the tag controller 42 of the mobile terminal 40 to write the information when the tag controller 42 of the mobile terminal 40 is authenticated with the second password information. Specifically, the second password information is stored in advance in the tag part 14 of the detection device 10 and the tag controller 42 of the mobile terminal 40, and the second password is transmitted together with a write signal from the tag controller 42 of the mobile terminal 40 to the detection device 10. If the received second password matches the second password stored in the tag part 14 (tag IC 14-1) of the detection device 10, the tag part 14 stores information included in the write signal. Thus, it is possible to restrict writing of information from devices other than the predetermined mobile terminal 40, and to prevent storage and transmission of erroneous information.

In addition, the data storage card 50 includes a plurality of types of data storage cards 50 (the network ID card 50-1, the operator ID card 50-2, the work content (for installation) card 50-3, and the work content (for use) card 50-4), and each of the plurality of types of data storage cards 50 has a plurality of types of corresponding colors (blue, yellow or cyan) corresponding to their respective types on its exterior part, and

the mobile terminal 40 includes a first light emitting unit (the ID light emitting unit 44-1 and the work content light emitting unit 44-2) configured to emit light in at least one of the plurality of types of corresponding colors, and a light emission controller (controller 41) configured to cause, when the tag controller 42 is in at least one of read standby or read completion of one of the plurality of types of data storage cards 50, the first light emitting unit to emit light in the corresponding color corresponding to the type of data storage card 50 that is the at least one of read standby and read completion. This allows the operator to instantly understand the data storage card 50 to be held over the mobile terminal 40, and can make the information acquiring work with respect to the mobile terminal 40 easier.

The light emission controller of the mobile terminal 40 causes, when the light emission controller is in the read standby of one of the plurality of types of data storage cards 50, the first light emitting unit to emit light in the corresponding color corresponding to the type of the data storage card 50 of the read standby in a first manner (blinking), and the light emission controller causes, when the light emission controller is in the read completion of one of the plurality of types of data storage cards 50, the first light emitting unit to emit light in the corresponding color corresponding to the type of the data storage card 50 of the read completion in a second manner (turning-on) different from the first manner. This allows the operator to instantly understand the data storage card 50 to be held over the mobile terminal 40, and can make the information reading completion with respect to the mobile terminal 40 easier.

In addition, the first light emitting unit includes a plurality of light emitting units arranged in a row. This makes it possible to instantly understand the order of the data storage cards 50 to be held over the mobile terminal 40, and make the information acquiring work with respect to the mobile terminal 40 easier.

In addition, the mobile terminal 40 includes a second light emitting unit (write status light emitting unit 44-3) configured to emit light in a first notification color (green) and a second notification color (red) different from the plurality of types of corresponding colors, and

the light emission controller causes, when the tag controller 42 is in at least one of write standby for and write completion into the tag part 14 of the detection device 10, the second light emitting unit to emit light in the first notification color, and the light emission controller causes, when the tag controller 42 is in at least one of write failure of the tag part 14 of the detection device 10, read failure of one of the plurality of types of data storage cards 50, and an error in a self-diagnosis function associated with initialization, the second light emitting unit to emit light in the second notification color. This makes it possible to instantly understand the status related to writing of the mobile terminal 40 and a status for reading or the like, and make the writing work using the mobile terminal 40 easier.

In addition, the mobile terminal 40 includes a sound output unit (buzzer 45) configured to output sound, and a sound controller (controller 41) configured to cause, when the tag controller 42 is in at least one of read completion and read failure of one of the plurality of types of data storage cards 50, write standby for and write completion into the tag part 14 of the detection device 10, and an error in a self-diagnosis function associated with initialization, the sound output unit to output a predetermined sound. This makes it possible to instantly understand the status of the mobile terminal 40 also through sound, and make the information acquiring work and writing work using the mobile terminal 40 easier.

The present invention is not limited to the exemplary embodiments described above, and a person skilled in the art will easily modify the exemplary embodiments described above to the extent included in the scope of the claims.

For example, in the status collecting system of the present invention, the measured object is not limited to a plant equipment in a plant, but it can be widely applied as long as it is an equipment whose status is determined mainly by temperature, vibration or the like. In the present embodiment, in the successful reading notification processes PC31-1, 31-2, 32-1, 32-2, 32-3, 33-1, 33-2, 33-3, 34-2, and 35-2, the write status light emitting unit 44-3 is temporarily turned on in green, but only the sound output by the buzzer 35 may be performed without causing the write status light emitting unit 44-3 to emit light. Further, in the error notification process, the ID light emitting unit 44-1 or the read status light emitting unit 44-2 (first light emitting unit) may emit light (for example, temporarily turned on) in a warning color (for example, red) other than the corresponding color.

### DESCRIPTION OF REFERENCE NUMERALS

1 plant-equipment status collecting system

10 detection device

11 controller of detection device

12 detection unit of detection device

13 network connection unit of detection device

14 tag part of detection device

15 notification unit of detection device

20 network construction device

30 data storage device

33 storage unit of data storage device

40 mobile terminal

41 controller of mobile terminal

42 tag controller of mobile terminal

44 light emitting unit of mobile terminal

45 buzzer of mobile terminal

50 data storage card

1. A status collecting system comprising: a detection device; a network construction device; a data storage device; a data storage card; and a mobile terminal, wherein
the detection device includes a detection unit configured to detect a status of a predetermined measured object and a tag part configured to store predetermined information in a non-contact manner, and transmits at least the status detected by the detection unit and detection device identification information for identifying the detection device to the network construction device through a network constructed by the network construction device,
the data storage device includes a storage unit configured to store at least the status and the detection device identification information received from the network construction device,
the data storage card stores the information and is communicatable with the mobile terminal in a non-contact manner,
the mobile terminal includes a tag controller configured to automatically read the information from the data storage card in a non-contact manner and to automatically store the information read in the tag part of the detection device in a non-contact manner, and
the detection device performs a predetermined operation when the information is stored in the tag part.

2. The status collecting system according to claim 1, wherein the data storage card includes at least a first data storage card for storing network information including network identification information for connecting to the network as the information,
the detection device transmits at least the network identification information to the network construction device when the network information is stored in the tag part, and
the network construction device determines whether or not to permit the detection device to connect to the network by using the network identification information.

3. The status collecting system according to claim 2, wherein the data storage card further includes a second data storage card for storing type information indicating a type of the detection unit as the information,
the tag controller of the mobile terminal can automatically read the type information from the second data storage card after automatically reading the network information from the first data storage card in a non-contact manner, and automatically store the network information and type information read in the tag part of the detection device in a non-contact manner, and
the detection device transmits the status detected by the detection unit corresponding to the type information stored in the tag part and the detection device identification information to the network construction device via the network.

4. The status collecting system according to claim 1, wherein the data storage card further includes a third data storage card for storing operator identification information for identifying an operator as the information, and a fourth data storage card for storing work content information indicating work contents of the operator as the information,
the tag controller of the mobile terminal can automatically read the operator identification information from the third data storage card in a non-contact manner, to read the work content information from the fourth data storage card after reading the operator identification information, and automatically store the operator identification information and work content information read in the tag part of the detection device in a non-contact manner,
the detection device transmits the operator identification information and the work content information stored in the tag part and the detection device identification information to the network construction device via the network, and
the data storage device stores, into the storage unit, the operator identification information, the work content information, and the detection device identification information received from the network construction device.

5. The status collecting system according to claim 1, wherein the data storage card stores first password information, and permits the tag controller of the mobile terminal to read the information when the tag controller of the mobile terminal is authenticated with the first password information.

6. The status collecting system according to claim 1, wherein the tag part of the detection device stores second password information, and permits the tag controller of the mobile terminal to write the information when the tag controller of the mobile terminal is authenticated with the second password information.

7. The status collecting system according to claim 1, wherein the data storage card includes a plurality of types of data storage cards, each of the plurality of types of data storage cards having a plurality of types of corresponding colors corresponding to the respective types on an exterior part thereof, and
the mobile terminal includes a first light emitting unit configured to emit light in at least one of the plurality of types of corresponding colors, and a light emission controller configured to cause, when the tag controller is in at least one of read standby or read completion of one of the plurality of types of data storage cards, the first light emitting unit to emit light in the corresponding color corresponding to the type of data storage card that is the at least one of read standby and read completion.

8. The status collecting system according to claim 7, wherein the light emission controller of the mobile terminal causes, in a case of the read standby of one of the plurality of types of data storage cards, the first light emitting unit to emit light in the corresponding color corresponding to the type of the data storage card of the read standby in a first manner, and the light emission controller causes, in a case of the read completion of one of the plurality of types of data storage cards, the first light emitting unit to emit light in the corresponding color corresponding to the type of the data storage card of the read completion in a second manner different from the first manner.

9. The status collecting system according to claim 8, wherein the first light emitting unit includes a plurality of light emitting units arranged in a row.

10. The status collecting system according to claim 7, wherein the mobile terminal includes a second light emitting unit configured to emit light in a first notification color and a second notification color different from the plurality of types of corresponding colors, and
the light emission controller causes, when the tag controller is in at least one of write standby for and write completion into the tag part of the detection device, the second light emitting unit to emit light in the first notification color, and the light emission controller causes, when the tag controller is in at least one of write failure into the tag part of the detection device, read failure of one of the plurality of types of data storage cards, and an error in a self-diagnosis function associated with initialization, the second light emitting unit to emit light in the second notification color.

11. The status collecting system according to claim 7, wherein the mobile terminal includes a sound output unit configured to output sound, and a sound controller configured to cause, when the tag controller is in at least one of read completion and read failure of one of the plurality of types of data storage cards, write standby for and write failure into the tag part of the detection device, and an error in a self-diagnosis function associated with initialization, the sound output unit to output a predetermined sound.
